(19) United States
(12) Patent Application Publication
(10) Pub. No.: US 2003/0019795 A1
(43) Pub. Date: Jan. 30, 2003

(54) Waste to resource

(76) Inventor: Gursel George Yilmaz, Bonita Springs, FL (US)

Correspondence Address: Gursel George Yilmaz, Ph.D., P.E., P.H., 28202 Meadowlark Lane, Bonita Springs, FL, 34134, US

(21) Appl. No.: 09/917,466

(22) Filed: Jul. 28, 2001

(51) Int. Cl. B03B 1/00

(52) U.S. Cl. 209/10; 209/930

(57) ABSTRACT

Waste management has been primarily based on collection of waste and placing most of it in a landfill or in an incinerator. Waste to resource eliminates a need for large landfills or incinerators by integrating collection of waste with separation and reuse of waste. Present invention eliminates a need for disposing readily usable materials into landfills or incinerators by separating and preparing as needed the usable materials for direct reuse such as environmental enhancements in coastal zone including active and passive coastal barrier systems such as artificial reefs. The coastal barriers systems are constructed along a selected depth that will enhance the hydrodynamics for more desirable self-maintained coastal biological and physical process. A portion of waste is processed and utilized together with other resource waste.

### FIELD OF THE INVENTION

The present invention lies in the field of civil engineering and more particularly in waste and resource management.

### BACKGROUND OF THE INVENTION

Waste to resource eliminates a need for disposing usable materials into large landfills or in an incinerator. Using waste to resource method, most of the waste stream is utilized as a resource such as environmental enhancements in coastal zone including active and passive coastal barrier systems, sub-merged artificial reefs, construction materials, wood and compost products, and resource for clean energy. Current and future landfill sites can also be used for treatment and processing resulting in a number of environmental benefits. The benefits include but not limited to

construction of active or passive coastal barrier systems using a portion of construction and demolition waste stream (C&D) through a decontamination and certification process,

integration of fluid dynamics characteristics associated with passive and active coastal barriers to optimize environmental benefits in a coastal zone system,

enhancement of coastal zone diversity, fisheries, diving related activities and related tourism,

protection of costly beach renourishment project investments through managing sediment transport through fluid dynamics and modeling and by achieving self maintained wave and coastal system energy spectrum.

Voluminous prior art reviewed showed improving large landfills and waste management by means of landfill reclamation, landfill mining, landfill bioreactors and recovery. However, prior art reviewed did not demonstrate a novel approach of Waste-to-Resource method. Some examples of voluminous prior art on processing and disposal of waste management are summarized below.

U.S. Pat. No. 1,329,105 discloses an apparatus for solid waste disposal and treatment in tower like structures having a number of chambers which air conduits extent vertically through said chambers.

U.S. Pat. No. 1,832,179 discloses treatment of organic refuse into useful substances by injecting air into moistened refuse.

U.S. Pat. No. 2,798,800 discloses a process which includes windrow referred as pile of unsegregated municipal refuse. The windrow is tumbled to provide necessary oxygen within said windrow to support aerobic process as needed.

U.S. Pat. No. 3,298,821 discloses a method and apparatus for decomposing waste material by aerobic process which is promoted and optimized by conditions designed for aerobic bacterial activity.

U.S. Pat. No. 3,419,377 discloses a method for treating organic and inorganic waste material. Said material is pulverized, mixed, and moistened to start fermentation prior to a digestor chamber.

U.S. Pat. No. 4,844,813 discloses a system and process for treatment of biodegradable waste which includes a land treatment area underlain by an impermeable layer and surrounded by dikes. A leachate collection system permits effluent collection and routes said effluent to a wastewater treatment system.

U.S. Pat. No. 4,543,016 discloses underground leachate barrier and method which includes digging a trench adjacent a contaminated area, placing a liquid impervious membrane on one side of said trench, and positioning drain pipe and risers surrounded by filter gravel within said trench.

U.S. Pat. No. 5,078,882 discloses bioconversion reactor and system which is claimed to be useful for the biological transformation of waste material into ecologically desirable materials. Said system is referred and defined as a group of zones including bioreactor zone, solids ecoreactor zone, georeactor zone, all of which said zones are interconnected. Said system includes wetlands, marshes, wastes land filled under soil like material with marsh plants.

U.S. Pat. No. 5,201,609 discloses cellular landfill process and apparatus wherein solid waste are disposed of in a landfill repository that maintains them in a state indefinitely using water and gas tight cells.

U.S. Pat. No. 5,265,979 discloses a high efficiency waste placement system for municipal landfills which includes shredding the solid waste, adjusting the moisture of the waste, installing an aeration system in a configured pile of said solid waste, covering the pile for aerobic decomposition, compacting the waste pile to be covered with a synthetic cover.

U.S. Pat. No. 5,348,422 discloses method for the formation and operation of in situ process reactor using a mobile trenching machine which converts a contaminated site to a reactor by simultaneously placing contaminant impermeable walls while processing excavated materials such as adding reactor reagents.

U.S. Pat. No. 5,356,452 discloses a method and apparatus for reclaiming waste materials. Waste materials are placed over impermeable liner in a domed structure. The decomposition of the waste material is controlled and monitored and after a period of time, the material within one or more cells is recovered and recycled.

U.S. Pat. No. 5,429,454 discloses a method for landfill reclamation which primarily includes excavation of waste materials from a landfill, separation of excavated waste materials, recovery of recyclable from excavated waste materials, and placing unrecoverable excavated waste materials back into the landfill.

U.S. Pat. No. 5,564,862 discloses a method of improved landfill mining which comprises converting the landfill to aerobic production by injection of air, moisture, and sludge for increased rate of decomposition, and excavating the landfill to remove waste materials, separating the removed waste material, and returning the residual to the landfill.

U.S. Pat. No. 6,117,671 discloses an integrated solid waste management method including collection of waste and processing it under wet and waste categories.

Prior art reviewed as summarized above do not demonstrate a new novel method of Waste-to-Resource through which Resource Waste and Waste for reuse are created.

### SUMMARY OF THE INVENTION

Waste management has been primarily based on collection of waste and placing a significant portion of it in a landfill or a bioreactor or an incinerator. Present invention eliminates a need for disposing readily usable materials by separating and preparing the usable materials portion of the waste stream for direct reuse such as environmental enhancements in coastal zone including active and passive coastal barrier systems, and sub-merged artificial reefs. The coastal barrier systems are constructed along a selected depth that will enhance the hydrodynamics for more desirable self-maintained coastal biological and physical process. Mostly construction and demolition (C&D) portion of waste stream is utilized for construction of active and passive coastal barrier systems as sub-merged artificial reefs and coastal barrier systems along a selected configuration that will enhance the hydrodynamics of a coastal zone for protection of beaches against erosion, and to establish more desirable self maintained coastal process. Current and future landfill sites can also be used for processing C&D and bio-mass portions of the waste stream resulting in a number of environmental benefits.

Prior art reviewed demonstrated that a number of methods and apparatus which improved a concept of incinerators and large landfills which consist of burying waste under controlled environmental conditions and long term monitoring of said conditions. However, prior art reviewed does not demonstrate a new comprehensive novel method and apparatus that will significantly reduce the waste stream including C&D and bio-mass. Present invention makes collection and transportation of readily reusable, mostly C&D and Bio-mass portion of waste, a significant part of recovery, and reuse. Remaining portion of the waste is processed for reuse, and remaining unusable inert is stored for further processing.

Waste stream is collected and transported as resource waste and waste most of which are separated and prepared for reuse. Said resource waste and waste are accepted by resource waste delivery system and waste delivery system respectively. Waste processing system includes recovery and reuse of recyclables. Resource Waste includes portions of construction demolition materials such as concrete and iron bars and masonry and dry wood. Although it is preferred to eliminate large landfill sites, present invention may be used in association with or as a part of a landfill site depending on the waste stream and market conditions. One of the benefits of using the present invention is elimination of multiple handling and processing of resource waste portion of waste. The following is a partial list of benefits of the present invention:

1. Usable C&D portion of the resource waste is directly re-used or recycled including establishing active and passive coastal barriers and artificial reefs for environmental resource enhancements and coastal zone management and protection;

2. Usable botanical and cellulose portion of the resource waste is directly re-used or recycled or converted into clean energy fueled by botanical and cellulose waste separated and decontaminated such as trees and paper and cardboard products, therefor eliminating unwanted pollutant discharges associated with burning plastics, rubber, and metals;

3. Local political considerations and challenges such as relocation of existing landfills due to odor problems and incinerators due to pollutant discharges are more easily met or overcome using waste to resource.

### BRIEF DESCRIPTION OF THE DRAWINGS

FIG. 1 shows a process chart of the present invention including a waste generator, resource waste and waste, a transportation system, and re-use.

FIG. 2 shows a process chart of the resource waste, direct reuse, and associated use such as resources.

FIG. 3 shows a process chart of the waste, waste processing, and associated resources.

FIG. 4 shows processing of construction and demolition (C&D) waste portion of waste stream for reuse including associated resource and uses.

FIG. 5 shows processing of organic and botanical waste portion of waste stream for reuse including associated resources.

FIG. 6 shows waste stream separation and processing and associated re-use.

FIG. 7 shows processing C&D portion of waste stream for reuse.

FIG. 8 shows processing composite portion of waste stream for reuse.

FIG. 9 shows processing organics and botanical and portion of waste stream for reuse.

FIG. 10 shows direct reuse and transportation system for coastal resource waste.

FIG. 10.1 shows a sea based transportation and discharge system for coastal resource waste.

FIG. 10.2 shows a sea-based transportation and discharge system for coastal resource waste.

FIG. 11 shows a sea-based transportation and discharge system for coastal resource waste.

FIG. 12 shows a method of operating a waste to resource system to produce energy resources.

### DETAILED DESCRIPTION OF THE PREFERRED EMBODIMENTS

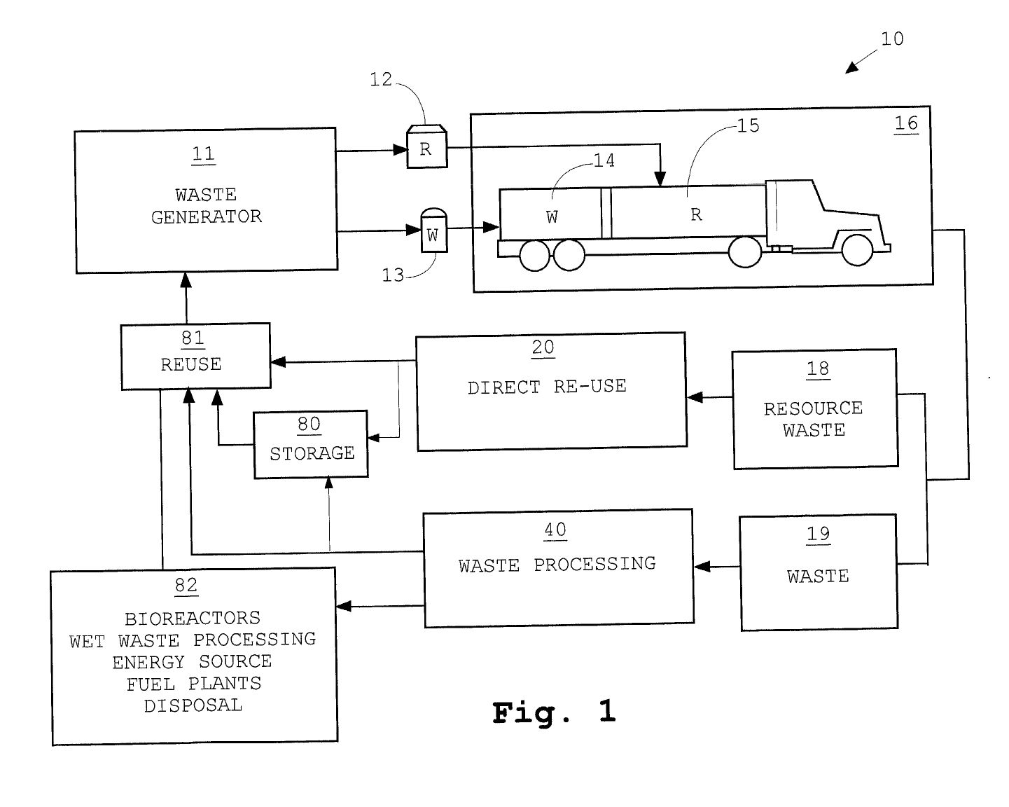

FIG. 1 shows process chart 10 including summary of the present invention showing a waste generator 11, preferred separation of waste into groups of at least resource waste 18 and waste 19 as initially contained in resource waste generator container 12 and a waste generator container 13 respectively, a transportation system 16, waste processing 40, and direct re-use and recycling 20. Said transportation system 16 is preferred to have two transportation containers 14 and 15 for waste 19 and resource waste 18 respectively. Waste 19 is prepared through processing 40 for storage 80 and reuse 81 or further processing 82. Resource waste 18 is directly re-used. Any waste which can not be cost effectively processed or reused is stored or further processed using one or a combinations of a methods of 82.

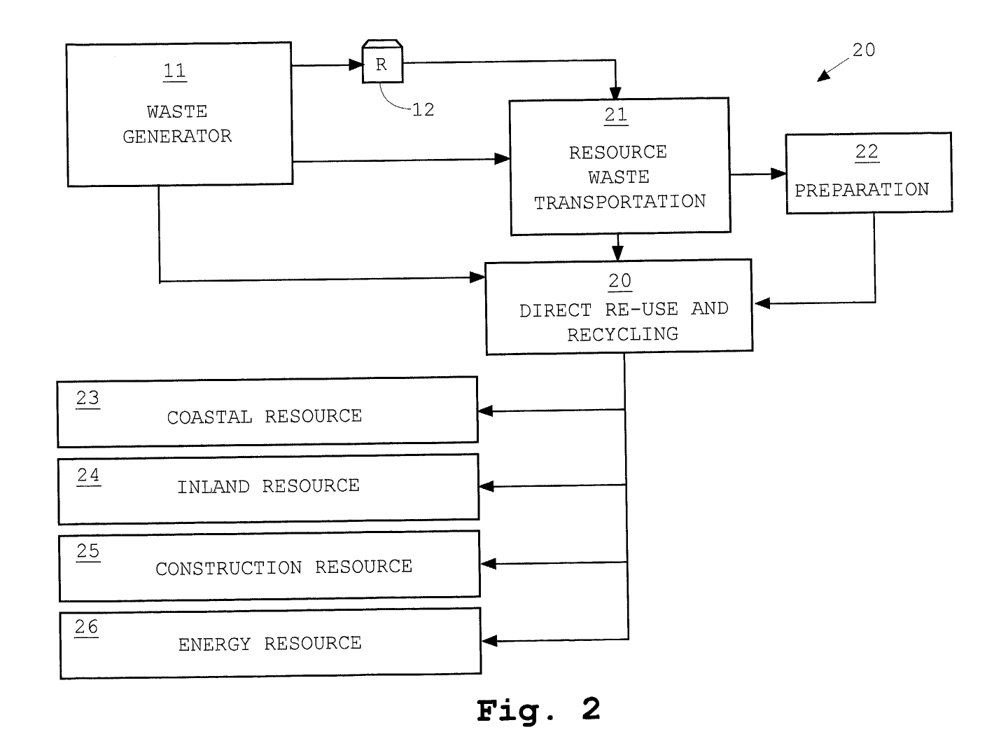

FIG. 2 shows resource waste being transported through a resource waste transportation system 21 and preparation 22. Resource waste is prepared or transported directly for Coastal Resource Re-use 23, Inland resource re-use 24, Construction Resource Reuse 25 such as aggregate materials, Energy resource Reuse 26 such as gassifiers and clean burners. Yard waste, bio-mass and other BTU valued waste that are not contributing to dioxin and other contaminant air emissions that contains chlorinated hydrocarbons are the primary source of energy fuel. Coastal Resource Reuse 23 such as artificial reefs, coastal active and passive barriers are designed to enhance the coastal environmental resources as well as to protect coastal zone including natural and renourished beaches, and environmental resources.

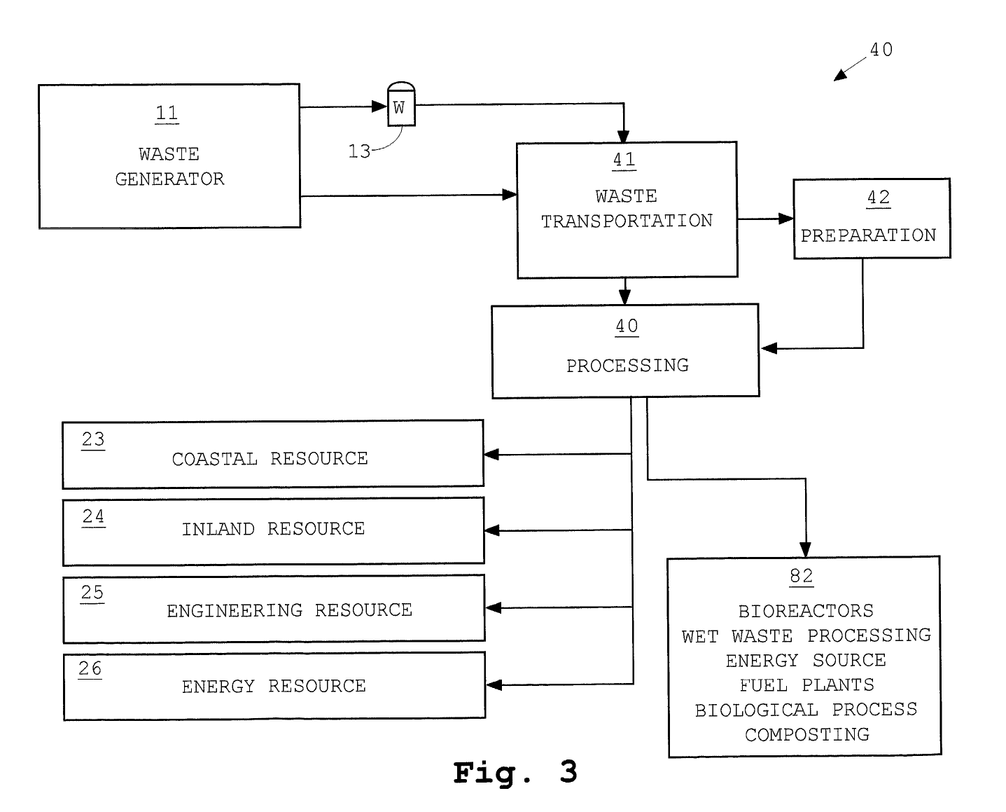

FIG. 3 shows waste generator 11 and waste container 13 and a waste transportation system 41 along with preparation 42 leading to processing 40 for producing materials for Coastal Resource Re-use 23, Inland resource re-use 24, Engineering Resource Reuse 25 such as aggregate materials, Energy resource Reuse 26 such as clean burners utilizing bio mass and other BTU valued waste which do not include any waste that contributes to dioxin and other contaminants in air emissions such as chlorinated hydrocarbons. Remaining portion of the waste 13 is stored or further processed using one or a combination of the methods 82 as shown in FIG. 3.

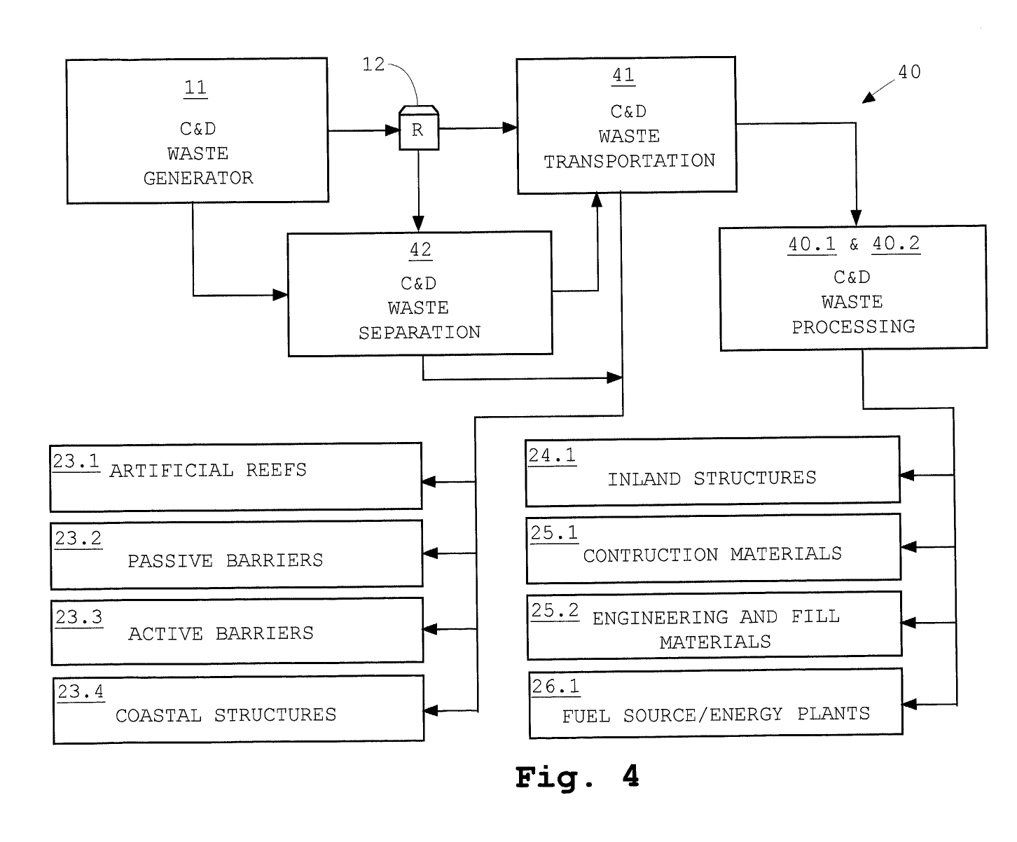

FIG. 4 shows a Construction & Demolishing (C&D) waste generator and a resource waste container 12 and C&D Resource Waste Separation 42. C&D Transportation System 41 receives waste from resource waste container 12 or from C&D waste separation. C&D waste processing 40.1 and 40.2 receives waste from C&D waste transportation system 41 and process the waste for use as resource for inland structures 24.1 and construction materials 25.1 and engineering and construction material 25.2 and fuel source and energy plants 26.1 such as clean burners and gassifiers. A portion of the C&D is separated using 42 and directly used for artificial reefs 23.1 and passive barriers 23.2 and active barriers 23.3 and coastal structures 23.4.

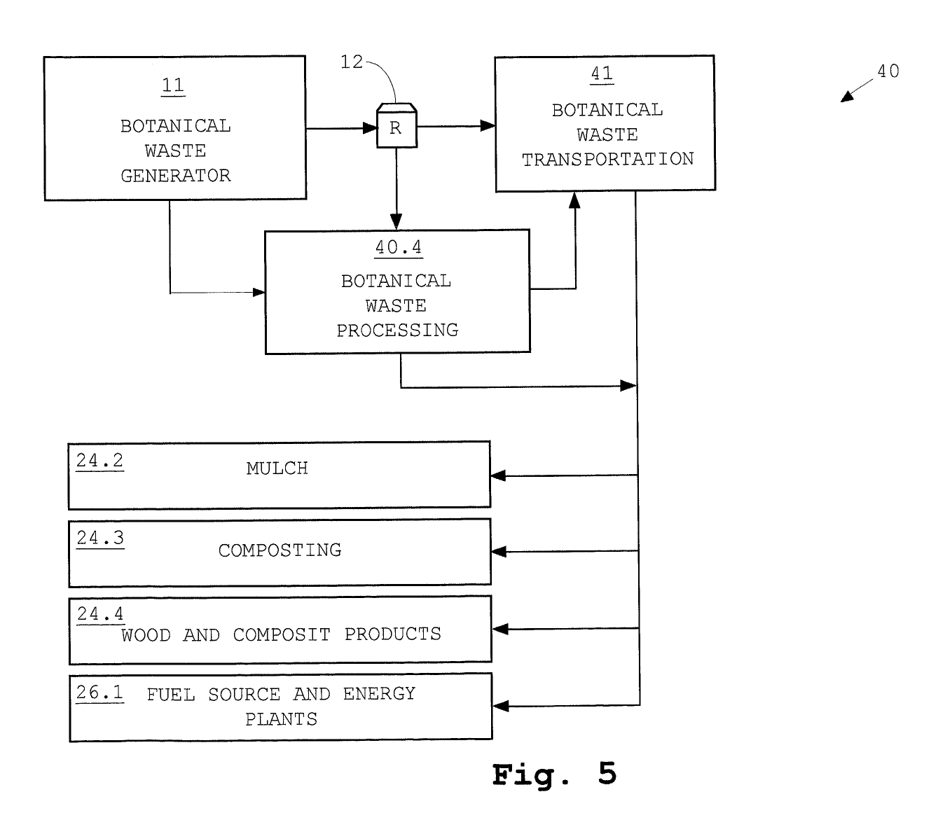

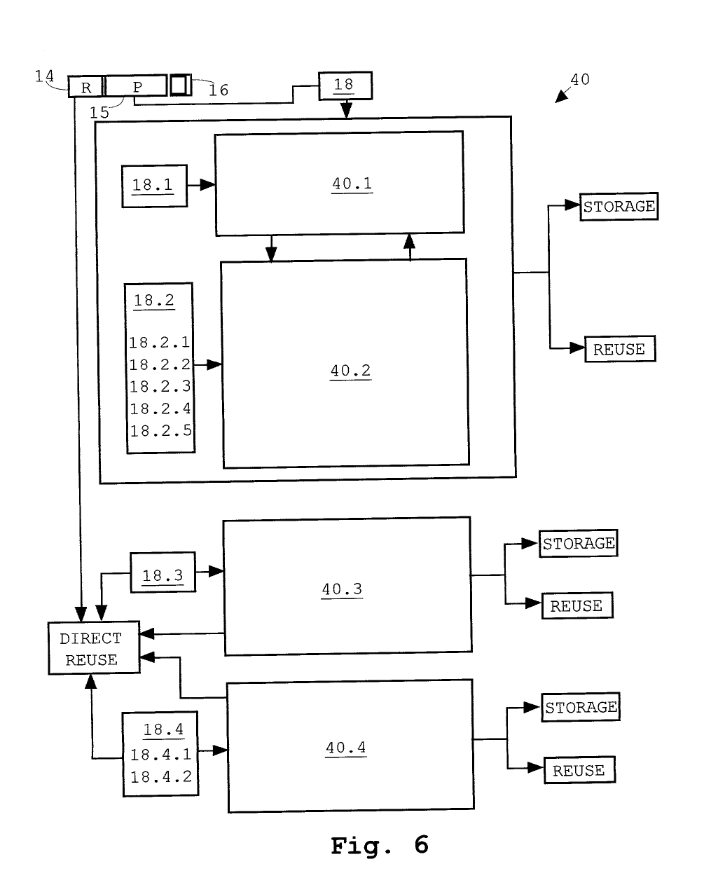

FIG. 5 shows a botanical waste generator and generator container 12 which temporarily stores as needed the said waste for botanical waste transportation 41 and the botanical waste is transported for one or a combination of mulching 24.2 and composting 24.3 and wood and composite products 24.4 and fuel source and energy plants 26.1. Processing 40.4 includes chipping yard waste to be mixed with bio-solids (sludge) for composting.

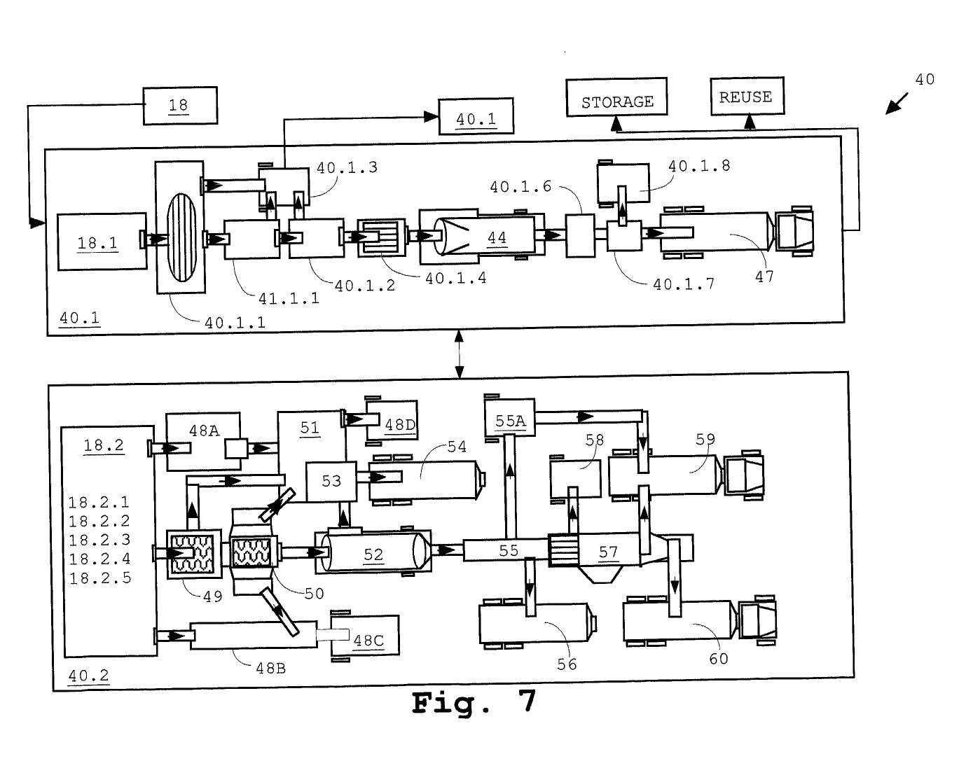

FIG. 6 shows an integrated waste processing 40 including waste group 18 which is preferred to be separated into five primary groups of 18.1, 18.2, 18.3, and 18.4 for processing and reuse. Waste 18 includes C&D and is defined by at least four primary groups of waste which are construction waste group 18.1, combined waste group 18.2, composite waste group 18.3 and botanical waste group 18.4. Waste groups 18.2 and 18.4 can be simultaneously collected and directly re-used or processed for use such as small and large concrete aggregate bonded together to build artificial reefs. Iron bars could also be added to the mix.

A construction waste separation and processing unit 40.1 receives construction waste group 18.1. Integrated processing platform 40 separates said waste group 18.1 into 18.2.1, 18.2.2, 18.2.3, 18.2.4, and 18.2.5 all of which are send to processing 40.2. FIG. 7 shows a high throughput capacity multi dimensional and multi-radius circular gear separator unit 40.1.1. Said unit 40.1.1 separates 18.1. Remaining large pieces of waste 18.1 into smaller which then goes to construction waste post segregation unit 40.1 where metals and plastics and wood are separated in mobile container 40.1.3 for further processing using processing 40.2. Remaining portion of said waste 18.1 is crushed using multi layer crushing unit 40.1.4 for size reductions as desired and send to hammermill unit 40.1.5. Aggregate chips from said hammermill unit 40.1.5 is decontaminated using construction waste decontamination unit 440.1.6 and separated into different size products using multi screen 40.1.7 including rotational gear screens and send to mobile container 40.1.8 for further processing using processing 40.2.

FIG. 7 show combined waste group 18.2 which consist of at least one or more of aggregate waste 18.2.1 and plastic waste 18.2.2 and metal waste 18.2.3 such as ferrous and aluminum waste and glass waste 18.2.4 and white goods 18.2.5. Said combined waste group 18.2 is separated and processed using combined waste processing unit 40.2. White goods 18.2.5 are separated as much as possible using separator platform 48B and accepted by mobile container 48C. Using separator platform 48A, ready portion of waste 18.2 is segregated as much as possible and send directly to primary decontamination unit 51 to be accepted by mobile container 48D. Remaining of said combined waste 18.2 is accepted by primary dynamic screen 49 and secondary dynamic screen 50. Most of the loose aggregate portion of said combined waste is captured and separated by said primary and secondary dynamic screen 49 and 50 respectively and send to primary decontamination unit 51 which is connected to secondary soil decontamination unit 53. Said units 51 and 53 are to eliminate potential contaminants such as hydrocarbons and heavy metals. Remaining portion of said combined waste is accepted by multi screen trommel 52 through which all remaining aggregate waste is separated and send to secondary soil decontamination unit 53 and accepted by mobile storage unit 54 for reuse. All remaining portion of said combined waste passes through said trommel 52 and accepted by magnetic separator 55 which collects ferrous portion of metal waste 18.2.3 which is accepted in mobile storage 56 for reuse. Using said separator 55, glass waste 18.2.5 is also collected by mobile container 55A. An air separator 57 separates plastic waste 18.2.2 and remaining non ferrous portion of metal waste 18.2.3 and remaining glass waste 18.2.5 which are collected in mobile storage 60, 59 and 55A respectively for reuse. All waste 18.1 and 18.2 directly recovered and is utilized as resource. FIG. 4 shows also more specific uses of the resource waste for artificial reefs 23.1 and passive barriers 23.2 and active barriers 23.3 and coastal structures 23.4. Processed C&D waste also can be used as a resource for coastal zone by creating a mixture with binding material such as concrete and the selected products from processing 40.

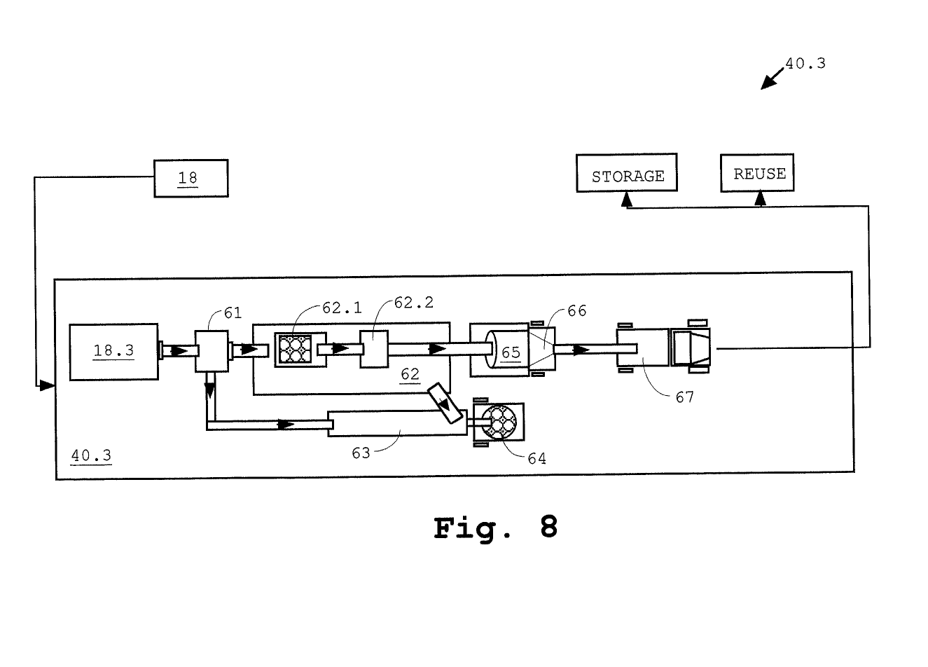

FIG. 8 shows a composite waste separation and processing unit 40.3 accepts composite waste group such as plywood and other composites waste 18.3. A portion of said waste is selected using pre-selection and post selection units 61 and 63 respectively and contained in 64 for reuse. Processing unit 62 consist of pre-wash unit 62.1 and decontamination unit 62.2. Remaining portion of said waste is accepted by cross chipper 65 for processing and reduced to desired different sizes and collected in a mobile storage 67 for reuse. A composite production resource facility can also take products from processing 40.3 and 40.4 to manufacture composites products.

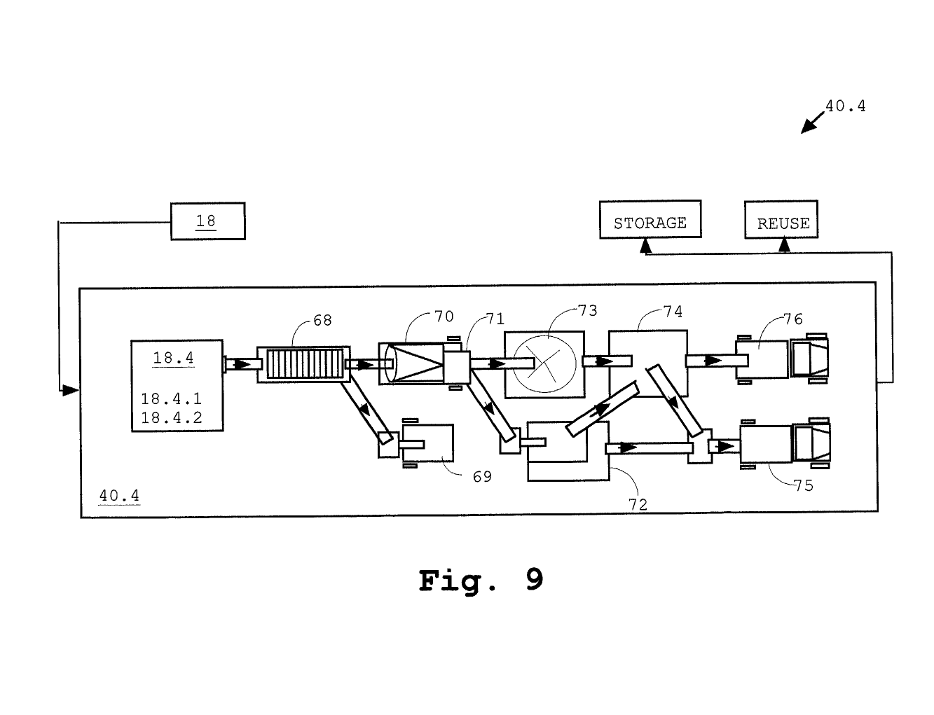

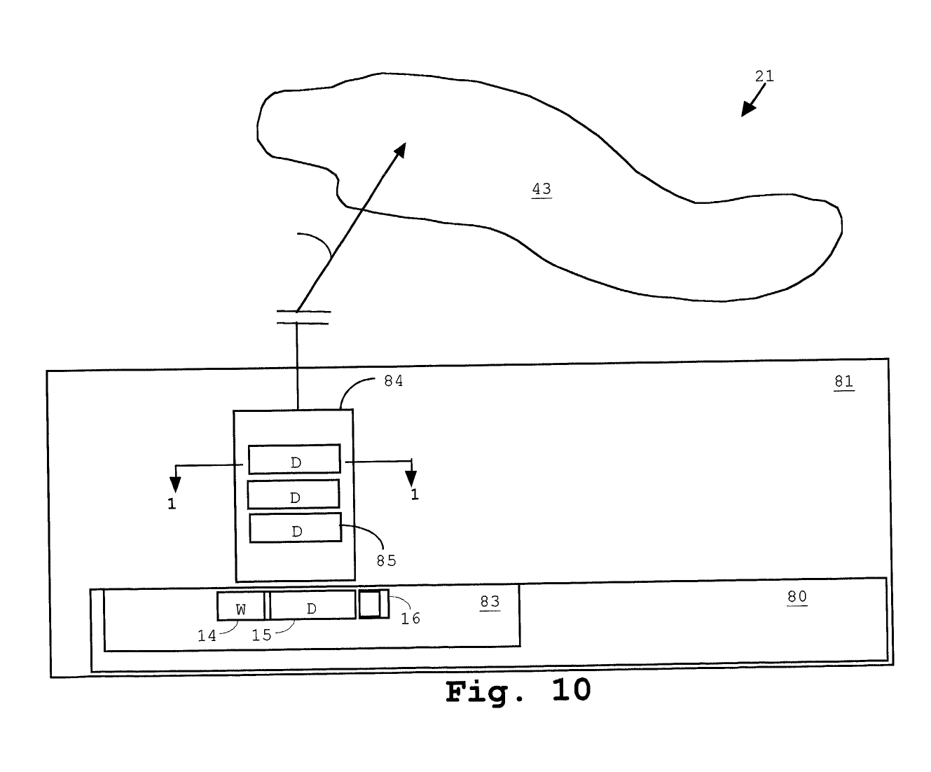

FIG. 9 shows a botanical waste separation and processing unit 40.4 receives botanical waste group 18.4 consisting of at least yard waste 18.4.1 such as grass clippings, tree trims, and wood waste 18.4.2 such as trees and wood from land clearing activities, and other organic waste such as bio-solids and bio-mass. All reusable wood is recovered using separation platform 68 and sent to a mobile storage 69. Remaining portion of the said waste group is sent to tree and multi-grade wood chipper 70 to be reduced to desired sizes and segregated using botanical multi grade screen 71 for composting 73 or mulch storage 72. A botanical decontamination unit 74 is used as needed for biological, chemical, or physical decontamination. Different grades of mulch from 74 or composting 73, and mulch storage 72 are accepted as needed by mobile storage 75 or 76 for reuse.

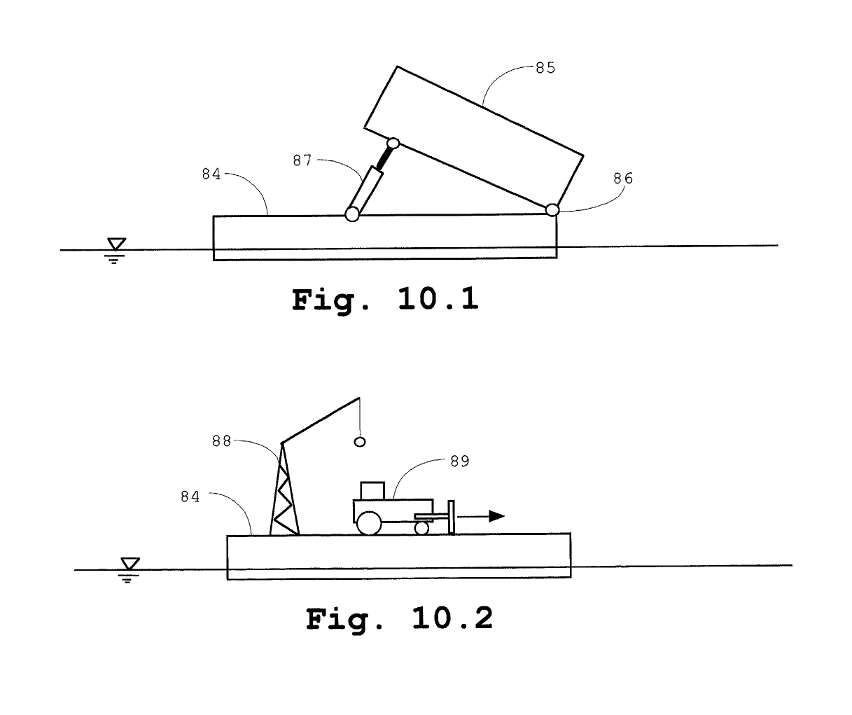

FIG. 10 shows resource waste transportation system 21 and land based transportation sub system 80 and sea based transportation sub-system 81. Said land based transportation system 41 includes sub-system 21 where applicable. A sea based transportation sub-system 80, and a sea and land based transfer station 83 connects said land based transportation sub-system 80 and said sea based transportation sub-system 81. Said resource waste transportation system 21 includes a vessel 84 which accept a portion of usable resource waste 14 for coastal resources 23. Said vessel is towed or self powered. A resource waste container 85 can be placed on the said vessel 84 as shown in FIG. 10.1 and FIG. 10.2. and said container 85, where needed, is connected to a resource waste discharge system 86. Said discharge system includes said container and container rotational connector 86, and lift sub-system 87 powered by mechanical or electrical or hydraulics. Said vessel can also be utilized as the transport surface without a container using a secondary discharge sub-system including a lift devise 88 as shown in FIG. 10.1 or push devise 89 as shown in FIG. 10.2.

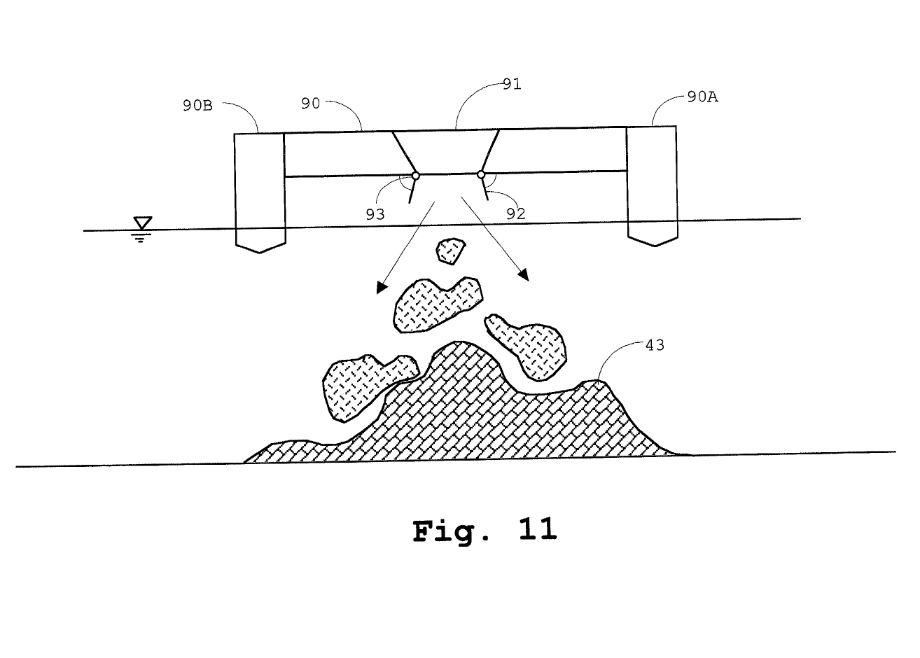

FIG. 11 shows coastal resource waste transportation comprising a vessel having a main hall 90 and buoyancy halls 90A and 90B on the sides of said main hall. Said main hall has a discharge port for the resource waste 14 being converted into an artificial reef 23.1 through which a controlled construction of an artificial reef is achieved. Said discharge port includes gates 92 connected to said main hall using connectors 93. Said gates are closed during the transportation and opened where the construction of an artificial reef is located.

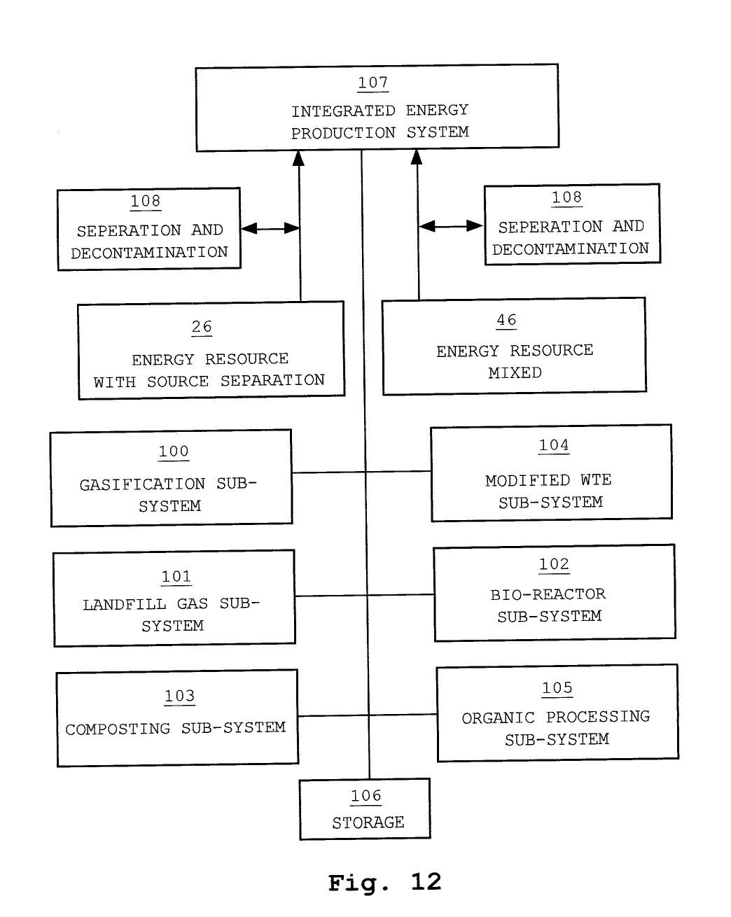

FIG. 12 shows a method of operating a waste to resource system to produce matter and energy resources including at least one or a combination comprising

separating waste into groups of at least energy resource 26 and mixed energy waste 46 and

processing said mixed waste 46 to generate energy and re-use and using said energy resource 26 directly, a gasification sub-system 100,

a landfill gas management sub-system 101, a bioreactor sub-system 102, a composting sub-system 103, a modified WTE sub-system 104, and a wet biological processing sub-system 105.

A storage 106 is included as needed into an integrated energy production system 107. Said sub-system 104 is modified WTE to achieve higher performance and clean burn using waste to resource which separates and decontaminates the fuel source by creating multiple energy resource. Said integrated energy production system included as needed a decontamination sub-systems 108A and 108B. To achieve above with a lower cost in processing a said method of source separation and decontamination is preferred to include decontaminating resource waste where necessary.

A multiple energy sources are created to generate power through electricity or heat using waste to energy method. Where WTE plants exist, waste to resource can include WTE plants with or without modifications to improve performance as well as the emission discharges related to plastics and other synthetic materials. In summary, the benefits of waste to resource include but not limited to

construction of active or passive coastal barrier systems using C&D portion of waste stream through a decontamination and certification process,

integration of passive and active coastal barriers to optimize environmental benefits in a coastal zone system,

enhancement of fisheries, diving related activities and related tourism,

protection of costly beach renourishment project investments through managing sediment transport by improving the self maintained wave and coastal system energy spectrum,

Producing organic soil and mulch for agricultural and landscaping uses, and

producing resources for clean burn energy plants and creating materials for bio-fuel plants.

While I have fully shown and described embodiments of my method for waste to resource no limitations as to the scope of the present invention should be implied from the foregoing description. The true scope of the present invention is limited only by the following claims.

I claim:

1. A method of operating a waste to resource system which integrates separation with reuse of waste stream comprising
separating said waste stream into groups of at least resource waste and waste,
processing said waste portion of said waste steam for reuse, and
re-using said resource waste portion of said waste stream directly.

2. A method as set forth in claim 1 includes collection and transportation sub-system for said waste stream comprising
collecting said resource waste and said waste,
transporting said resource waste and said waste, and
preparing said waste and resource waste for re-use.

3. A method as set forth in claim 1 includes said processing for C&D portion of said waste stream comprising
accepting said C&D waste from a C&D transportation sub-system,
separating said C&D waste using a C&D waste separation sub-system for reuse or processing, and
processing said C&D waste using a C&D processing sub-system including decontamination for reuse.

4. A method as set forth in claim 1 includes said processing for composite waste portion of said waste stream comprising
accepting said composite waste from a composite transportation sub-system, and
separating and processing said composite waste using a composite waste processing sub-system and processing said composite waste for reuse.

5. A method as set forth in claim 1 includes said processing for botanical waste including bio-mass and bio-solids portion of said waste stream for comprising
accepting said waste from a botanical waste transportation sub-system,
separating and processing said botanical waste using a botanical waste processing sub-system including decontamination for reuse including use for an energy source.

6. A method of operating a waste to resource system which integrates separation with recovery and reuse of C&D waste portion of waste stream comprising
separating said C&D waste into groups of at least resource waste and waste,
processing said waste portion of C&D waste for reuse,
re-using directly said resource waste portion of C&D waste for coastal zone management including constructing one or a combination of
passive barriers,
active barriers,
break waters, and
artificial reefs.

7. A method of operating a waste to resource system as set forth in claim 6 includes resource waste transportation system comprising
a land based transportation sub-system,
a sea based transportation sub-system, and
a sea and land based transfer station that connects said land based transportation sub-system and said sea based transportation sub-system.

8. A method of operating a waste to resource system as set forth in claim 6 includes sea based transportation sub-system comprising
a sea transport sub-system which accepts and delivers resource waste and said sea transport sub-system is self powered or powered by a secondary power source,
a resource waste discharge sub-system system connected to said sea transport sub-system.

9. A method of operating a waste to resource system to produce energy comprising
separating waste stream into groups of at least resource waste and waste,
using resource waste directly as energy resource to generate energy using one or a combination of following sub systems comprising
a gasification sub-system,
a landfill gas management sub-system,
a bioreactor sub-system,
a composting sub-system,
a modified WTE sub-system, and
a biological processing sub-system.

10. A method of separation as set forth in claim 9 includes
separating said waste stream into at least resource waste and waste by waste generator at the source,
decontaminating resource waste prior to direct use, and
decontaminating waste during said waste processing prior to re-use.

11. A method as set forth in claim 9 of operating a waste to resource system includes separation with recovery and reuse of bio-mass portion of waste stream comprising
separating said bio-mass into groups of at least resource waste and waste,
processing said waste for reuse including for energy source and biological process, and
re-using said resource waste portion of said bio-mass directly as a resource for energy plants and biological process.

12. A method as set forth in claim 9 includes separating waste stream into groups of at least resource waste and waste comprising
containing said waste in a waste generator container,
containing said resource waste in a resource waste generator container,
collecting said waste contained in said waste generator container and collecting said resource waste contained in said resource waste generator container and transporting said waste and said resource waste for re-use,
processing said waste and using said processed waste to generate energy using one or a combination of following sub systems comprising
a gasification sub-system,
a landfill gas management sub-system,
a bioreactor sub-system,
a composting sub-system,
a modified WTE sub-system, and
a biological processing sub-system.
